(19) United States
(12) Patent Application Publication
(10) Pub. No.: US 2009/0320791 A1
(43) Pub. Date: Dec. 31, 2009

(54) Four-Stroke Engine

(75) Inventor: Henglin Xiao, Jiangsu (CN)

Correspondence Address: THE WEBB LAW FIRM, P.C., 700 KOPPERS BUILDING, 436 SEVENTH AVENUE, PITTSBURGH, PA, 15219, US

(73) Assignee: WUXI KIPOR POWER CO., LTD., Jiangsu (CN)

(21) Appl. No.: 12/304,417

(22) PCT Filed: Apr. 3, 2007
(86) PCT No.: PCT/CN2007/001080

§ 371 Date: Dec. 11, 2008

(30) Foreign Application Priority Data
Sep. 30, 2006 (CN) 200610096274.0

(51) Int. Cl. F02B 75/02; F02B 75/32

(52) U.S. Cl. 123/311; 123/197.4

(57) ABSTRACT

A four-stroke engine includes a case which is comprised of a first case half and a second case half connected with each other at a parting plane which goes through centerline of a crankshaft and is perpendicular to centerline of a cylinder. A first bearing seat is divided into a first upper bearing seat half and a first lower bearing seat at the parting plane. A second bearing seat is divided into a second upper bearing seat half and a second upper bearing seat half at the parting plane. The first upper bearing scat half and the second upper bearing scat half are integrally molded on the first case half, and the first lower bearing seat half and the second lower bearing seat half are integrally molded on the second case half. An outer side surface of the first case half and a side cover form a valve-operating chamber for accommodating a valve-operating mechanism.

### TECHNICAL FIELD

The present invention relates to a four-stroke engine in the technical field of power device, in particular to a small type of four-stroke engine.

### BACKGROUND ART

Presently, in the conventional small type of four-stroke engine, the case of the engine is composed of a first case half and a second case half which are connected with each other at a parting plane, the extension of which is obliquely intersected with the axis of the first and second bearing seat for supporting the crankshaft. The cylinder and the first bearing seat is integrally molded on the first case half, the second bearing seat is integrally molded on the second case half. As to this type of engine, for effectively reducing the bending moment acted on the crankshaft by the piston and thereby enhancing the endurance of the crankshaft, the distance between the first bearing seat and the second bearing seat for supporting two ends of the crankshaft should be reduced as possible as we can.

However, in the conventional engine, the valve-operating mechanism is a hindrance to reduction of the distance between the first bearing seat and the second bearing seat, since the valve-operating mechanism connected with the crankshaft is arranged near inside portion of the second case half, That is, due to the hindrance of the valve-operating mechanism, at least one of the bearing seats can not be arranged near the crank portion of the crankshaft. When assembling the engine, it is necessary to temporarily mount a portion of the valve-operating mechanism onto the crankshaft before connecting the first case half and the second case half. Therefore, there is limitation and difficulty in the assembly of this engine.

### SUMMARY OF THE INVENTION

For overcoming the above-mentioned deficiencies in the prior art, an objective of the present invention is to provide a four-stroke engine. In the engine, the distance between the first bearing seat and the second bearing seat for supporting two ends. of the crankshaft is reduced without the interference of the valve-operating mechanism so that the endurance of the crank is enhanced. Additionally, it is easier to assemble the engine, since the valve-operating mechanism can be assembled after the first case half and the second case half are connected with each other. Furthermore, well-lubricating and hence life-span of all parts in the valve-operating chamber are ensured, since an oil-scattering impeller for scattering more lubricating oil-mist during operation of the crank is mounted in the crankcase of the four-stroke engine, which provides good lubrication for the engine.

To achieve the above-mentioned objective, the technical solution of the present invention is as follows:

A four-stroke engine mainly comprises: a case composed of a first case half and a second case half, a side cover connected with the case, a cylinder integral with a cylinder head, a piston accommodated in the cylinder, a combustion chamber formed between lower portion of the cylinder head and top surface of the piston, and a crankshaft having a crank portion connected with the piston via a connecting rod; wherein the first case half includes a first upper bearing seat half and a second upper bearing seat half for supporting bearings at two ends of the crankshaft respectively, while the second case half includes a first lower bearing seat half and a second lower bearing seat half for supporting bearings at two ends of the crankshaft respectively; the first case half and the second case half are connected with each other at a parting plane going through a centerline of the first upper bearing seat half and the second upper bearing seat half and being perpendicular to a centerline of the cylinder; that is, at a position going through a centerline of the crankshaft and being perpendicular to the centerline of the cylinder, the case of the engine is divided into the first case half and the second case half, a first bearing seat for supporting the crankshaft is divided into the first upper bearing seat half and the first lower bearing seat half, a second bearing seat for supporting the crankshaft is divided into the second upper bearing seat half and the second lower bearing seat half, wherein the first upper bearing seat half and the second upper bearing seat half are integrally molded on the first case half, and the first lower bearing seat half and the second lower bearing seat half are integrally molded on the second case half; an outer side surface of the first case half perpendicular to the centerline of the crankshaft and the side cover connected to the side surface of the first case half form a valve-operating chamber for accommodating a valve-operating mechanism.

In the present application, an oil-scattering impeller is mounted about a shaft on the sidewall of an oil storage chamber below the crankshaft. During the rotation of the crankshaft, the oil-scattering impeller can scatter more lubricating oil-mist, thereby reliably providing the lubrication for every part of the valve-operating mechanism.

In the present application, a crank timing gear is fixed on the crankshaft, and one of bearings is arranged between a crank portion of the crankshaft and the crank timing gear.

In comparison with the prior art, the present invention has the following advantages:

Firstly, the engine of the present invention has simple, compact and reasonable structure. Secondly, the endurance of the crank is enhanced since the distance between the first and the second bearing seats for supporting two ends of the crankshaft is reduced without the interference of the valve-operating mechanism and thereby the bending moment acted on the crankshaft by the piston is reduced. Finally, the parts of the crank and connecting rod mechanism and the valve-operating mechanism can be lubricated better while ensuring the life-span thereof and thereby enhancing the usage performance of the engine, since the oil-scattering impeller is additionally provided to produce more lubricating oil-mist.

### BRIEF DESCRIPTION OF THE DRAWINGS

FIG. 1 is a longitudinal sectional view of the four-stroke engine of the present invention;

FIG. 2 is a sectional view of the engine along A-A line;

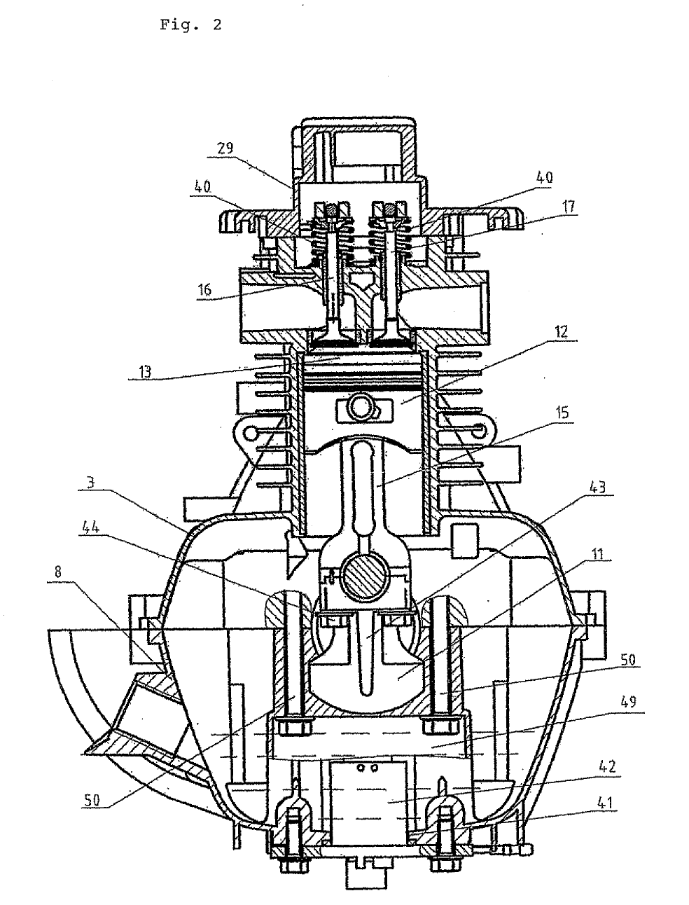

FIG. 3 is a sectional view of the engine along B-B line.

### DETAILED DESCRIPTION OF THE PREFERRED EMBODIMENTS

The present invention will be further described with reference to the embodiment shown in the drawings.

The engine of the present invention mainly comprises a case 1, an oil storage chamber 2, a first case half 3, a first upper bearing seat half 4, a second upper bearing seat half 5, a cylinder head 6, a cylinder 7, a second case half 8, a first lower bearing seat half 9, a second lower bearing seat half 10, a crankshaft 11, a piston 12, a combustion chamber 13, a crank portion 14, a connecting rod 15, an intake valve 16, an exhaust valve 17, a spark plug 18, a first bearing seat 19, a second bearing seat 20, a side cover 21, a first shaft neck portion 22, a second shaft neck portion 23, ball bearings 24,25, a valve-operating chamber 26, a shaft 27, an oil-scattering impeller 28, a cylinder head cover 29, a valve-operating mechanism 30, a crank timing gear 31, a driven timing gear 32, a driven shaft 33, a cam 34, tappets 35, a tappet shaft 36, rocker arms 37, a rocker arm shaft 38, pushing rods 39, a valve spring 40, an alarm-mounting hole 41, an oil alarm 42, an oil-scattering needle 43, a bolt 44, an electrical generator 45, a cooling fan 46, a fan hood 47, an oil seal 48, lubricating oil 49 and a bolt 50, etc.

The case 1 of the engine is defined by the first case half 3 and the second case half 8, wherein the first case half 3 is integrally molded from the first upper bearing seat half 4, the second upper bearing seat half 5 and the cylinder 7 integral with the cylinder head 6, while the second case half 8 is integrally molded from the oil storage chamber 2, the first lower bearing seat half 9 and the second lower bearing seat half 10 supported at two ends of the crankshaft 11. The cylinder 7 can accommodate the piston 12 which is connected with the crank portion 14 of the crankshaft 11 via the connecting rod 15. The combustion chamber 13 is formed between the lower portion of the cylinder head 6 and the top surface of the piston 12. The intake valve 16, the exhaust valve 17 and the spark plug 18 are mounted in the cylinder head 6 at the upper portion of the combustion chamber 13. The first case half 3 and the second case half 8 are connected with each other at a parting plane to constitute the case 1 of the engine, wherein the parting plane for dividing the case 1 into the first case half 3 and the second case half 8 goes through the centerline of the crankshaft 11 and is perpendicular to the centerline of the cylinder 7. The crankshaft 11 is supported by two ball bearings 24 and 25; the crank portion 14 of the crankshaft 11 is mounted between two ball bearings 24 and 25 and is provided with the first shaft neck portion 22 and the second shaft neck portion 23 respectively near two sides thereof. The first bearing seat 19 supported at the first shaft neck portion 22 is divided into the first upper bearing seat half 4 and the first lower bearing seat half 9 at the parting plane; similarly, the second bearing seat 20 supported at the second shaft neck portion 23 is divided into the second upper bearing seat half 5 and the second lower bearing seat half 10 at the parting plane. The first upper bearing seat half 4 and the second upper bearing seat half 5 are integrally molded on the first case half 3; similarly, the first lower bearing seat half 9 and the second lower bearing seat half 10 are integrally molded on the second case half 8. The oil seal 48 is mounted at outer side of the second bearing seat 20.

The outer side surface of the case 1 and the side cover 21 connected thereto form the valve-operating chamber 26. At outer side of the first bearing seat 19, the valve-operating chamber 26 is communicated with the oil storage chamber 2. The upper portion of the valve-operating chamber 26 extends to above cylinder head 6 by the sidewall of the cylinder 7 and is closed by the cylinder head cover 29 connected at the upper surface of the cylinder head 6. The valve-operating mechanism 30 is positioned in the valve-operating chamber 26 and is capable of opening and closing the intake valve 16 and the exhaust valve 17 by the rotation of the crankshaft 11.

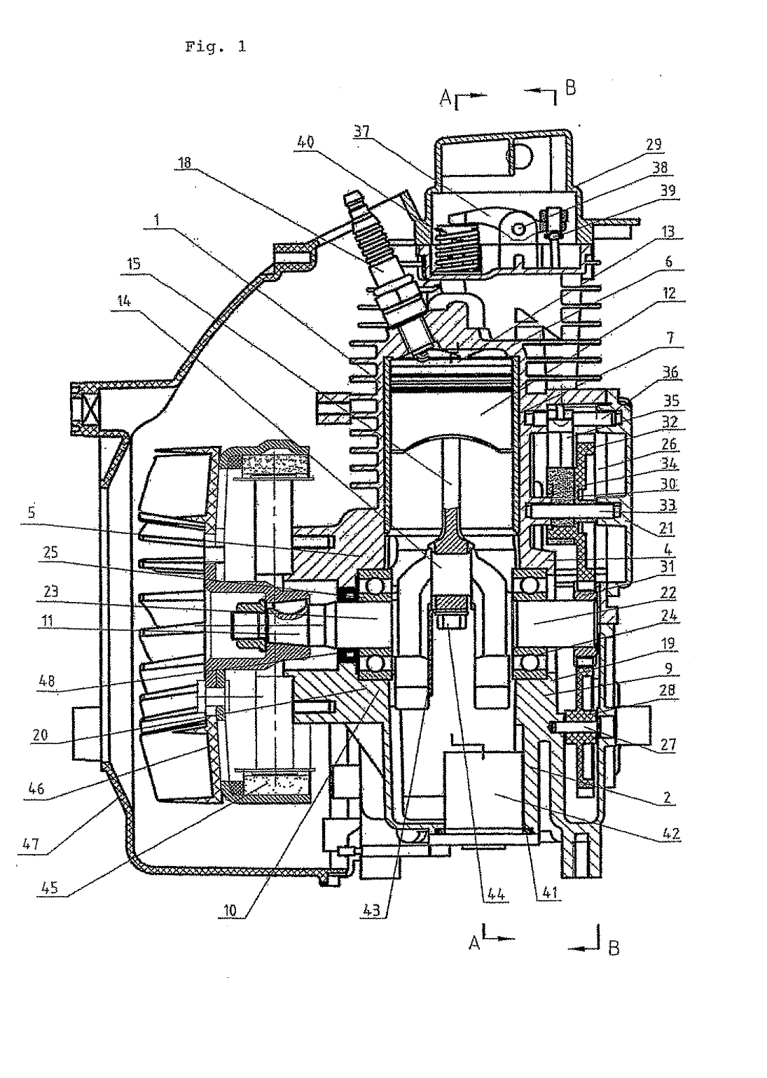

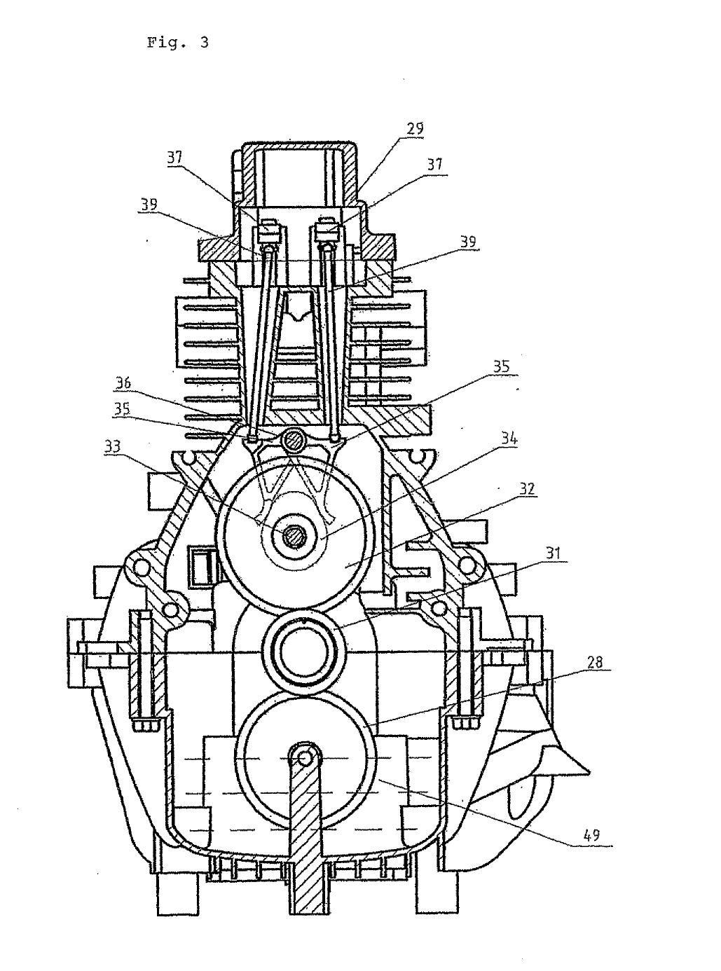

As shown in FIG. 1 and FIG. 3, the crank timing gear 31 included in the valve-operating mechanism 30 is fixed on the crankshaft 11 outside of the first bearing seat 19. One of the ball bearings 24 and 25 is arranged between the crank timing gear 31 and the crank portion 14. The driven timing gear 32 is mounted on the driven shaft 33 and is driven by the crank timing gear 31 in a transmission ratio of 2:1. The cam 34 is integral with the driven timing gear 32 and is freely rotated on the driven shaft 33 by the driven timing gear 32. One pair of tappets 35 are mounted on the tappet shaft 36 and can be driven by the cam 34 to freely rock on the tappet shaft 36. One pair of rocker arms 37 are mounted on the rocker arm shaft 38; ends of rocker arms 37 are connected to the head of the intake valve 16 and the exhaust valve 17, the other ends of rocker arms 37 are connected to the tappets 35 via one pair of pushing rods 39. The valve spring 40 exerts pressure to close the intake valve 16 and the exhaust valve 17. When the impulse face of the cam 34 push the pushing rod 39 upwards by the tappets 35, the intake valve 16 and the exhaust valve 17 are opened; when the base circle face of the cam 34 faces toward the tappets 35, the intake valve 16 and the exhaust valve 17 are closed by the valve spring 40.

The driven shaft 33 is supported on the case 1, the tappet shaft 36 is supported on the side cover 21, and the rocker arm shaft 38 is supported on the cylinder head 6.

The oil-scattering impeller 28 is mounted on the shaft 27 on the sidewall of the oil storage chamber 2 below the crankshaft 11 of the engine. A part of the oil-scattering impeller 28 is immerged in the lubricating oil 49 stored in the lower portion of the oil storage chamber 2. The oil-scattering impeller 28 can freely rotate on the shaft 27 by the driving of the crank timing gear 31 so that the lubricating oil 49 is scattered to lubricate each parts in the valve-operating chamber 26. Additionally, the oil alarm 42 is mounted in the alarm-mounting hole 41 at the bottom of the oil storage chamber 2.

The oil-scattering needle 43 fixed at the lower end of the connecting rod 15 via the bolt 44 can also scatter the lubricating oil 49. The electrical generator 45 is connected to one end of the crankshaft 11 and the cooling fan 46 is fixed on the electrical generator 45. The fan hood 47 is arranged outside the cooling fan 46 to guide the cooling gas of the cooling fan 46 toward the cylinder 7 and the cylinder head 6 and thereby cool them.

The engine can be assembled by the main steps as follows: firstly, mounting the ball bearings 24 and 25 onto the first shaft neck portion 22 and the second shaft neck portion 23 of the crankshaft 11 respectively; then installing the ball bearings 24 and 25 assembled with the crankshaft 11 into the first bearing seat 19 which is formed by the connection of the first upper bearing seat half 4 and the second upper bearing seat half 5 via bolt 50, and the second bearing seat 20 which is formed by the connection of the first lower bearing seat half 9 and the second lower bearing seat half 10 via bolt 50; next, locking the first case half 3 and the second case half 8 via bolts and mounting the valve-operating mechanism 30 into the valve-operating chamber 26; finally, connecting the side cover 21 and the cylinder head cover 29 to the case 1 via bolts. In this way, with the connection of the first case half 3 and the second case half 8, the crankshaft 11 can be reliably supported and the valve-operating mechanism 30 can be easily assembled.

The operation principle and process of the present invention is described hereinafter:

During the operation of the engine, due to the expansion or compression stroke, the piston 12 exerts a load onto the crank portion 14 of the crankshaft 11 via the connecting rod 15, and thereby onto the first bearing seat 19 and the second bearing seat 20. The load causes a bending moment to act on the crankshaft 11, particularly between the first bearing seat 19 and the second bearing seat 20. Since the distance between the first bearing seat 19 and the second bearing seat 20 is relatively short, the bending moment is relatively small. Since the valve-operating mechanism is arranged in the valve-operating chamber 26 outside the first bearing seat 19 and the bearing seats 19 and 20 are arranged near two ends of the crank portion 14 without the interference of the valve-operating mechanism 30, the distance between the first bearing seat 19 and the second bearing seat 20 is shortest and thereby the bending moment is smallest, which is beneficial for enhancing the endurance of the crank.

In the engine of the present invention, due to the expansion work of combustible gases in the combustion chamber 13, the piston 12 is pushed to reciprocate and thereby rotate the crankshaft 11 through the connecting rod 15, Subsequently, the crank timing gear 31 is rotated and thereby to rotate the driven timing gear 32 and the cam 34 in a transmission ratio of 2:1; and the rocker arms 37 is driven by the tappets 35 and the pushing rods 39 to rock, so that the opening of the intake valve 16 and the exhaust valve 17 can be controlled. When the cam 34 is rotated into a state in which the base circle face of the cam 34 faces toward the tappets 35, the intake valve 16 and the exhaust valve 17 are closed automatically by the action of the valve spring 40. Thereby, the work cycle of the engine is achieved. During the operation of the engine, the oil-scattering impeller 28 is driven by the crank timing gear 31. In this situation, since a part of the oil-scattering impeller 28 is immerged in the lubricating oil 49, the oil-scattering impeller 28 can scatter upwards the lubricating oil 49 stored in the oil storage chamber 2 while the oil-scattering needle 43 on the connecting rod 15 is stirring the lubricating oil. Thereby, the scattered oil and oil-mist can lubricate the valve-operating mechanism and other moving parts.

When the level of the lubricating oil is lowered than the a predetermined oil level, the oil alarm 42 mounted on the oil storage chamber 2 sends out an alarming signal to stop the operation of the engine, for preventing the engine from damage.

In this four-stroke engine, on one hand, the distance between the two bearing seats for supporting the crankshaft is shorten so that the endurance of the crankshaft is enhanced; on the other hand, since the valve-operating mechanism is arranged outside the first bearing, it is easy to assemble the valve-operating mechanism in the engine. Furthermore, since the oil-scattering impeller 28 is additionally provided to produce more lubricating oil-mist, the parts of the crank and connecting Rod Mechanism and the valve-operating mechanism can be lubricated better and thereby the usage performance of the engine is enhanced. The present invention is not limited to the above embodiment, which can also be applied to other four-stroke engine.

1. A four-stroke engine comprising: a case composed of a first case half and a second case half, a side cover connected with the case, a cylinder integral with a cylinder head, a piston accommodated in the cylinder, a combustion chamber formed between lower portion of the cylinder head and top surface of the piston, and a crankshaft having a crank portion connected with the piston via a connecting rod; wherein the first case half includes a first upper bearing seat half and a second upper bearing seat half for supporting bearings at two ends of the crankshaft respectively, while the second case half includes a first lower bearing seat half and a second lower bearing seat half for supporting bearings at two ends of the crankshaft respectively; the first case half and the second case half are connected with each other at a parting plane going through a centerline of the first upper bearing seat half and the second upper bearing seat half and being perpendicular to a centerline of the cylinder; that is, at a position going through a centerline of the crankshaft and being perpendicular to the centerline of the cylinder, the case of the engine is divided into the first case half and the second case half, a first bearing seat for supporting the crankshaft is divided into the first upper bearing seat half and the first lower bearing seat half, a second bearing seat for supporting the crankshaft is divided into the second upper bearing seat half and the second lower bearing seat half, wherein the first upper bearing seat half and the second upper bearing seat half are integrally molded on the first case half, and the first lower bearing seat half and the second lower bearing seat half are integrally molded on the second case half; an outer side surface of the first case half perpendicular to the centerline of the crankshaft and the side cover connected to the side surface of the first case half form a valve-operating chamber for accommodating a valve-operating mechanism.

2. The four-stroke engine according to claim 1, wherein an oil-scattering impeller is mounted about a shaft on the sidewall of an oil storage chamber below the crankshaft.

3. The four-stroke engine according to claim 1, wherein a crank timing gear is fixed on the crankshaft, and one of bearings is arranged between a crank portion of the crankshaft and the crank timing gear.

4. The four-stroke engine according to claim 2, wherein a crank timing gear is fixed on the crankshaft, and one of bearings is arranged between a crank portion of the crankshaft and the crank timing gear.
